(19) United States
(12) Patent Application Publication
(10) Pub. No.: US 2006/0164228 A1
(43) Pub. Date: Jul. 27, 2006

(54) Rearview mirror with multiple monitors

(76) Inventor: Huan-Chin Tseng, Hsinchu (TW)

Correspondence Address: Rabin & Berdo, P.C., Suite 500, 1101 14th Street, Washington, DC, 20005, US

(21) Appl. No.: 11/036,327

(22) Filed: Jan. 18, 2005

(51) Int. Cl. B60Q 1/00; H04N 7/18; G02B 5/08; G08G 1/14

(52) U.S. Cl. 340/461; 359/844; 348/148; 340/435; 340/932.2

(57) ABSTRACT

A rearview mirror has a housing, a reflector, multiple displays and a controlling device. The housing has a body, an opening, a chamber and a securing device. The opening is defined in one side of the body. The chamber is defined in the body and communicates with the opening. The securing device is mounted on the body to allow the housing to be connected to the vehicle. The reflector is mounted on the body to close the opening in the body. The displays are secured in the chamber of the housing. The controlling device is attached to the body of the housing, is electrically connected to the displays and is adapted to communicate with multiple signal sources. The displays are visible through the reflector when the displays are actuated to provide image or information and the displays are not visible when the displays are not actuated.

### BACKGROUND OF THE INVENTION

1. Field of the Invention

The present invention relates to a rearview mirror, and more particularly to a rearview mirror with multiple monitors to be connected to multiple cameras attached to a rear end of a vehicle.

2. Description of Related Art

A rearview mirror is a basic piece of equipment in a car and is attached to an interior ceiling by a connecting plate so as to reflect the traffic situation behind the car. To improve the function of the rearview mirror, a display is mounted on the rearview mirror to show the situation behind the car and information on the display is provided by a camera attached to the rear end of the car.

However, the conventional rearview mirror has only a single display connected to a single camera, so that the conventional mirror cannot show every situation occurring behind the vehicle, especially to a truck, and blind spots of the camera frequently cause problems.

To overcome the shortcomings, the present invention tends to provide a rearview mirror to mitigate or obviate the aforementioned problems.

### SUMMARY OF THE INVENTION

The main objective of the invention is to provide a rearview mirror that has multiple displays. The rearview mirror has a housing, a reflector, multiple displays and a controlling device. The housing has a body, an opening, a chamber and a securing device. The opening is defined in one side of the body. The chamber is defined in the body and communicates with the opening. The securing device is mounted on the body to allow the housing to be connected to the vehicle. The reflector is mounted on the body of the housing to close the opening in the body. The displays are secured in the chamber of the housing. The controlling device is attached to the body of the housing, is electrically connected to the displays and is adapted to communicate with multiple signal sources. The displays are visible through the reflector when the displays are actuated to provide image or information and the displays are not visible when the displays are not actuated.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a rearview mirror in accordance with the present invention;

FIG. 2 is an exploded cross sectional top plan view of the rearview mirror in FIG. 1;

FIG. 3 is a cross sectional top plan view of the rearview mirror in FIG. 1;

FIG. 4 is a perspective view of another embodiment of a rearview mirror in accordance with the present invention;

FIG. 5 is a block diagram of a controlling system of the rearview mirror in FIG. 1; and

FIG. 6 is a view of a rear end of a truck with two cameras connected to the rearview mirror in accordance with the present invention.

### DETAILED DESCRIPTION OF PREFERRED EMBODIMENT

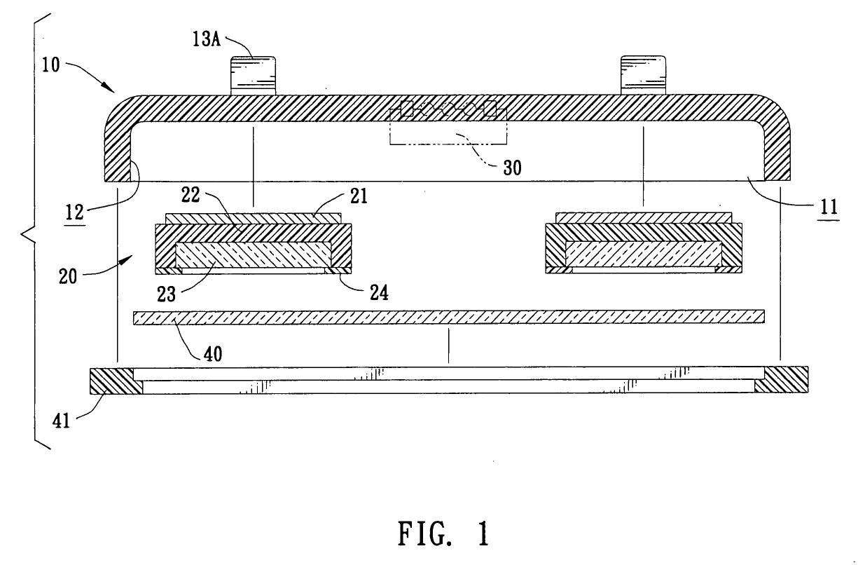

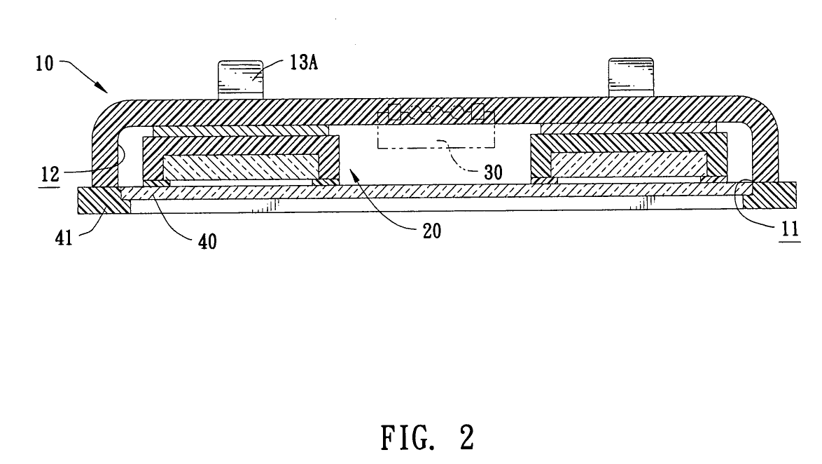

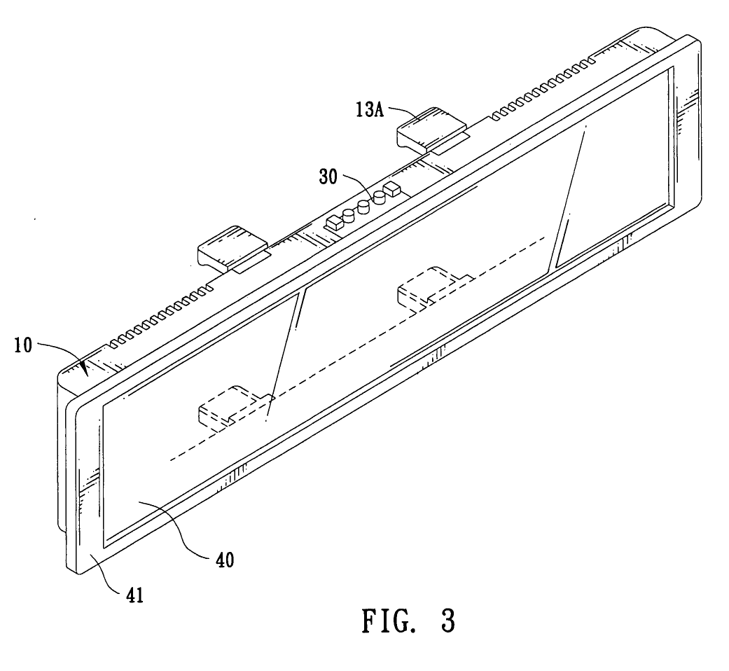

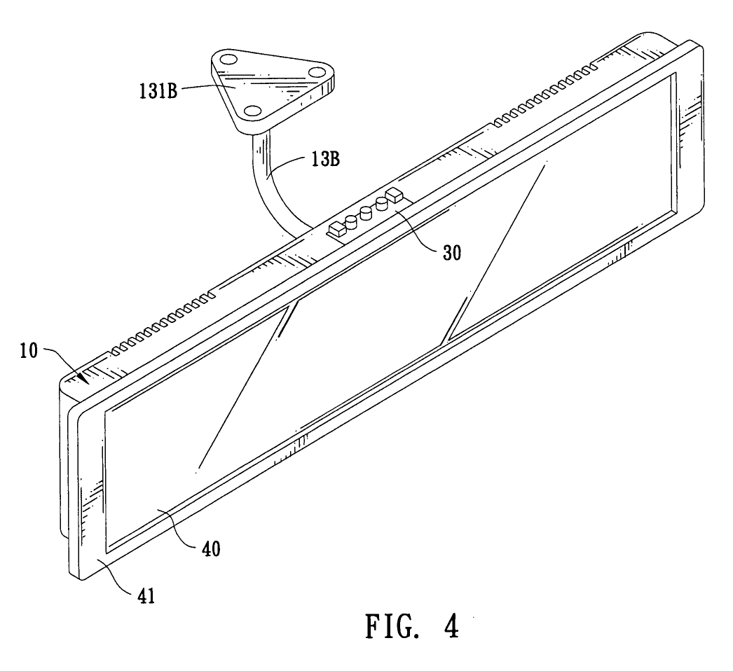

With reference to FIGS. 1 to 3, a rearview mirror in accordance with the present invention comprises a housing (10), a reflector (40), multiple displays (20) and a controlling device (30). The housing (10) has a body, an opening (11), a chamber (12) and a securing device. The opening (11) is defined in one side of the body, and the chamber (12) is defined in the body and communicates with the opening (11). The securing device is mounted on the body to allow the housing (10) to be connected to a vehicle. In a first embodiment, the securing device comprises multiple clamps (13A) extending from the body of the housing (10), such that the housing (10) can be securely attached to a conventional rearview mirror of the vehicle. In a second embodiment, with reference to FIG. 4, the securing device comprises a connecting arm (13B) and a connecting base (131B). The connecting arm (13B) extends from the body of the housing (10) and has a distal end. The connecting base (131B) is mounted on the distal end of the connecting arm (13B). With the connecting arm (13B) and the connecting base (131B), the housing (10) can be securely attached with bolts to a ceiling of a vehicle.

The reflector (40) is mounted on the body of the housing (10) to close opening (11) in the body and has a reflecting effect like a mirror but also is pervious to light. A reflector holder (41) is attached to the housing to securely hold the reflector (40) in position.

The displays (20) are secured in the chamber (12) of the housing (10). In a preferred embodiment, two displays (20) are mounted inside the chamber (12) and are located respectively near two ends of the body of the housing (10). The displays (20) are visible through the reflector (40) when the displays (20) are actuated to provide image or information, and the displays (20) are not visible when the displays (20) are not actuated. In a preferred embodiment, each display (20) is a liquid crystal display (LCD) and comprises a case (22), a circuit board (21), a screen (23) and a masking frame (24). The structure of the display (20) can be conventional and is not further described.

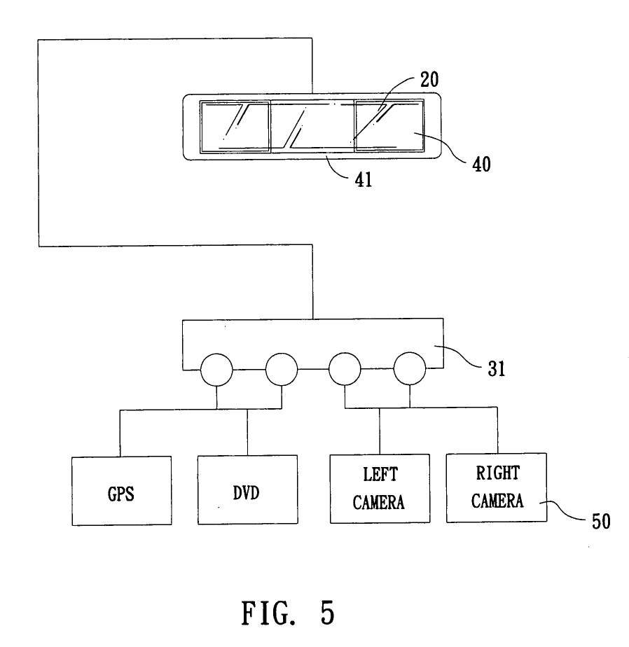

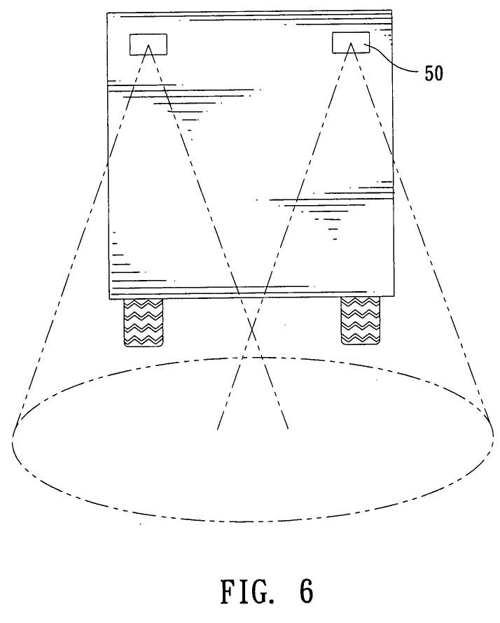

With further reference to FIGS. 5 and 6, the controlling device (30) is attached to the body of the housing (10) and is electrically connected to and communicates with the displays (20) and multiple signal sources. A power supply is provided to drive the displays but as this is conventional, further description thereof is omitted for brevity. The signal sources can be a global positioning system (GPS), a digital video disk (DVD) display or cameras (50) attached to the rear end of the vehicle. The controlling device (30) comprises multiple signal jacks (31) and multiple buttons (32). The signal jacks (31) are attached to the body of the housing (10) and are electrically connected to the displays (20) and the signal sources to transmit signal to the displays (20) from the signal sources. The buttons (32) are attached to the body of the housing (10) and are electrically connected to the displays (20).

Accordingly, the displays (20) can show the images shot by the cameras (50) mounted on different locations on the vehicle, such that blind spots of the situation behind the vehicle will not occur. The vehicle driver can clearly see all of the situations behind the vehicle via the displays (20), and the safety of driving or backing up of the vehicle is improved. In addition, by pressing the buttons (32), the displays (20) can be switched to show images transmitted from different signal sources, such that the rearview mirror is versatile.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A rearview mirror comprising:
a housing having
a body;
an opening defined in one side of the body;
a chamber defined in the body and communicating with the opening; and
a securing device mounted on the body to allow the housing to be connected to a vehicle;
a reflector mounted on the body of the housing to close opening in the body; and
multiple displays secured in the chamber of the housing;
a controlling device attached to the body of the housing, electrically connected to the displays and adapted to communicate with multiple signal sources,
wherein the displays are visible through the reflector when the displays are actuated to provide image or information and the displays are not visible when the displays are not actuated.

2. The rearview mirror as claimed in claim 1, wherein
two displays are mounted inside the chamber and are located respectively near two ends of the body of the housing.

3. The rearview mirror as claimed in claim 2, wherein the controlling device comprises
multiple signal jacks attached to the body of the housing, electrically connected to the displays and adapted to be electrically connected to the signal sources to transmit signals to the displays; and
multiple buttons attached to the body of the housing and electrically connected to the displays.

4. The rearview mirror as claimed in claim 3, wherein the securing device comprises multiple clamps extending from the body of the housing.

5. The rearview mirror as claimed in claim 4 further comprising a reflector holder attached to the housing to securely hold the reflector in position.

6. The rearview mirror as claimed in claim 3, wherein the securing device comprises
a connecting arm extending from the body of the housing and having a distal end; and
a connecting base mounted on the distal end of the connecting arm.

7. The rearview mirror as claimed in claim 6 further comprising a reflector holder attached to the housing to securely hold the reflector in position.

8. The rearview mirror as claimed in claim 1, wherein the controlling device comprises
multiple signal jacks attached to the body of the housing, electrically connected to the displays and adapted to be electrically connected to the signal sources to transmit signals to the displays; and
multiple buttons attached to the body of the housing and electrically connected to the displays.

9. The rearview mirror as claimed in claim 8, wherein the securing device comprises multiple clamps extending from the body of the housing.

10. The rearview mirror as claimed in claim 9 further comprising a reflector holder attached to the housing to securely hold the reflector in position.

11. The rearview mirror as claimed in claim 8, wherein the securing device comprises
a connecting arm extending from the body of the housing and having a distal end; and
a connecting base mounted on the distal end of the connecting arm.

12. The rearview mirror as claimed in claim 11 further comprising a reflector holder attached to the housing to securely hold the reflector in position.

13. The rearview mirror as claimed in claim 1, wherein the securing device comprises multiple clamps extending from the body of the housing.

14. The rearview mirror as claimed in claim 13 further comprising a reflector holder attached to the housing to securely hold the reflector in position.

15. The rearview mirror as claimed in claim 1, wherein the securing device comprises
a connecting arm extending from the body of the housing and having a distal end; and
a connecting base mounted on the distal end of the connecting arm.

16. The rearview mirror as claimed in claim 15 further comprising a reflector holder attached to the housing to securely hold the reflector in position.

17. The rearview mirror as claimed in claim 1 further comprising a reflector holder attached to the housing to securely hold the reflector in position.
